(19) United States
(12) Patent Application Publication
(10) Pub. No.: US 2026/0360309 A1
(43) Pub. Date: Nov. 12, 2026

(54) PIXEL, DISPLAY DEVICE INCLUDING THE SAME AND ELECTRONIC DEVICE INCLUDING THE SAME

(71) Applicant: Samsung Display Co., LTD., Yongin-si (KR)

(72) Inventors: Mu Kyung JEON, Yongin-si (KR); Il Joo KIM, Yongin-si (KR); Seung Hee LEE, Yongin-si (KR); Jung Hun YI, Yongin-si (KR)

(21) Appl. No.: 19/393,987

(22) Filed: Nov. 19, 2025

(30) Foreign Application Priority Data
May 12, 2025 (KR) 10-2025-0061474

(51) Int. Cl. G09G 3/3233; G09G 3/32

(52) U.S. Cl. CPC G09G 3/3233; G09G 3/32; G09G 2300/0819; G09G 2300/0852; G09G 2310/08

(57) ABSTRACT

A pixel includes a light emitting element connected between a first power node and a second power node; a first transistor which controls an amount of light emitting current flowing from the first power node to the second power node via the light emitting element based on a voltage of a first node; a first capacitor connected between the first node and a fourth node; a second capacitor connected between the fourth node and the first power node; and a switch transistor connected between the first power node and the fourth node and including a gate electrode connected to a select power line.

This application claims priority to Korean Patent Application No. 10-2025-0061474, filed on May 12, 2025, and all the benefits accruing therefrom under 35 U.S.C. §119, the content of which in its entirety is herein incorporated by reference.

### BACKGROUND

### 1. Field

The present disclosure relates to a pixel, a display device including the pixel, and an electronic device including the pixel.

### 2. Description of the Related Art

With the development of information technology, the importance of display devices as a connection medium between users and information is becoming increasingly important. In response to this, the use of display devices such as liquid crystal display devices, organic light emitting display devices, inorganic light emitting display devices, and the like is increasing.

The above description is intended only to provide an understanding of the background technology for the technical ideas of the present disclosure, and therefore it should not be understood as constituting prior art known to those skilled in the art of the present disclosure.

### SUMMARY

A pixel, a display device including the pixel, and an electronic device including the pixel according to embodiments of the present disclosure provide a pixel capable of expressing a high brightness image depending on a driving mode.

A pixel according to an embodiment of the present disclosure includes a light emitting element connected between a first power node and a second power node; a first transistor which controls an amount of light emitting current flowing from the first power node to the second power node via the light emitting element based on a voltage of a first node; a first capacitor connected between the first node and a fourth node; a second capacitor connected between the fourth node and the first power node; and a switch transistor connected between the first power node and the fourth node and including a gate electrode connected to a select power line.

In an embodiment, in a first mode, the switch transistor may be in a turn-off state, and in a second mode, the switch transistor may be in a turn-on state.

In an embodiment, the pixel may further include a second transistor including a first electrode connected to a data line, a second electrode connected to the second node, and a gate electrode connected to a first gate line; a third transistor including a first electrode connected to a third node, a second electrode connected to the first node, and a gate electrode connected to the first gate line; and a fourth transistor including a first electrode connected to the first node, a second electrode connected to a first initialization line, and a gate electrode connected to a second gate line.

In an embodiment, a horizontal period of a frame may include a first period, a second period, and a third period, the fourth transistor may be in a turn-on state during the first period, the first transistor, the second transistor, and the third transistor may be in a turn-on state during the second period, and the second transistor and the third transistor may be in the turn-off state during the third period.

In an embodiment, in the third period, a voltage of the first node in the second mode may be lower than a voltage of the first node in the first mode.

In an embodiment, the pixel may further include a fifth transistor including a first electrode connected to the first power node, a second electrode connected to a second node, and a gate electrode connected to an emission line; a sixth transistor including a first electrode connected to the third node, a second electrode connected to a fifth node, and a gate electrode connected to the emission line; and a seventh transistor including a first electrode connected to the fifth node, a second electrode connected to a second initialization line, and a gate electrode connected to a third gate line.

In an embodiment, the first capacitor and the second capacitor may be connected to each other in series.

In an embodiment, the switch transistor may be a P-type transistor.

A display device according to an embodiment of the present disclosure includes pixels connected to gate lines, emission control lines, and data lines; a gate driver which drives the gate lines; and a driver integrated circuit (IC) which supplies a control signal to the gate driver. In such an embodiment, a pixel of the pixels includes a light emitting element connected between a first power node and a second power node; a first transistor which controls an amount of light emitting current flowing from the first power node to the second power node via the light emitting element based on a voltage of a first node; a first capacitor connected between the first node and a fourth node; a second capacitor connected between the fourth node and the first power node; and a switch transistor connected between the first power node and the fourth node and including a gate electrode connected to a select power line supplied with a select voltage.

In an embodiment, the driver IC may turn off the switch transistor in a first mode and may turn on the switch transistor in a second mode via the select voltage.

In an embodiment, the gate driver may supply a first gate line of the gate lines with a first gate signal including a first period, a second period, and a third period based on the control signal, the first gate signal may be transitioned from a high level to a low level when changed from the first period to the second period, and the first gate signal may be transitioned from a low level to a high level when changed from the second period to the third period.

In an embodiment, in the second mode, the gate driver may change a horizontal length of the second period of the first gate signal from a first horizontal length to a second horizontal length, and the second horizontal length may be shorter than the first horizontal length.

In an embodiment, a voltage of the first node during the third period when the second period has the second horizontal length, may be less than a voltage of the first node during the third period when the second period has the first horizontal length.

In an embodiment, the driver IC may include a data driver that includes a lookup table including a first gamma set and a second gamma set different from the first gamma set, and outputs a data signal based on either the first gamma set or the second gamma set, and the data driver may output the data signal by reading out the first gamma set from the lookup table when the second period has the first horizontal length.

In an embodiment, the data driver may output the data signal by reading out the second gamma set from the lookup table when the second period has the second horizontal length.

In an embodiment, the driver IC may reduce a slew rate of the first gate signal when the second period has the second horizontal length to be lower than the slew rate thereof when the second period has the first horizontal length.

The pixel of the pixels may further include an initialization transistor including a first electrode connected to the first node, a second electrode connected to a first initialization line which supplies a first initialization voltage, and a gate electrode connected to a second gate line which is a corresponding one of the gate lines, and the driver IC may reduce the first initialization voltage when the second period has the second horizontal length to be lower than the first initialization voltage when the second period has the first horizontal length.

In an embodiment, the first capacitor and the second capacitor may be connected to each other in series.

In an embodiment, the switch transistor may be a P-type transistor.

An electronic device according to an embodiment of the present disclosure includes a processor which provides input image data; and a display device which displays an image based on the input image data. In such an embodiment, the display device includes pixels connected to gate lines, emission control lines, and data lines; a gate driver which drives the gate lines; and a driver IC which supplies a control signal to the gate driver. In such an embodiment, a pixel of the pixels includes a light emitting element connected between a first power node and a second power node; a first transistor which controls an amount of light emitting current flowing from the first power node to the second power node via the light emitting element based on a voltage of the first node; a first capacitor connected between the first node and a fourth node; a second capacitor connected between the fourth node and the first power node; and a switch transistor connected between the first power node and the fourth node and including a gate electrode connected to a select power line supplied with a select voltage.

According to embodiments of the present disclosure, it is possible to provide a pixel capable of expressing a high brightness image depending on the driving mode.

The features of embodiments of the present disclosure are not limited by the above examples, and various other features are included in the present disclosure.

### BRIEF DESCRIPTION OF THE DRAWINGS

FIG. 1 is a block diagram illustrating an embodiment of a display device.

FIG. 2 is a block diagram illustrating an embodiment of one of sub-pixels of FIG. 1.

FIG. 3 is a circuit diagram to illustrate a sub-pixel according to an embodiment of the present disclosure.

FIG. 4 is a signal timing diagram to illustrate the operation of the sub-pixel of FIG. 3.

FIGS. 5-9 are circuit diagrams to illustrate the operation of the sub-pixel of FIG. 3.

FIG. 10 is a block diagram illustrating a configuration of a controller and a data driver according to an embodiment of the present disclosure.

FIG. 11 is a signal timing diagram showing a waveform of a select voltage of FIG. 10 according to a driving mode.

FIG. 12 is a diagram showing a voltage at a first node of a sub-pixel during a first period, a second period, and a third period according to an embodiment of the present disclosure.

FIG. 13 is a block diagram to illustrate the operation of a controller and a data driver according to another embodiment of the present disclosure.

FIG. 14 is a diagram showing a voltage at a first node of a sub-pixel during a first period, a second period, and a third period according to another embodiment of the present disclosure.

FIG. 15 is a block diagram illustrating a controller according to another embodiment of the present disclosure.

FIG. 16 is a signal timing diagram illustrating the principle of operation of a signal timing controller of FIG. 15.

FIG. 17 is a drawing to illustrate a pixel according to another embodiment of the present disclosure.

FIG. 18 is a block diagram of an electronic device according to an embodiment.

FIG. 19 is a schematic diagram of an electronic device according to various embodiments.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

Throughout the specification, when a part is said to be "connected" to another part, this includes not only when it is "directly connected" to, but also when it is "indirectly connected" with other elements in between. The terms used herein are intended to describe specific embodiments and are not intended to limit the present disclosure.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms such as "below", under", "on", "above" and the like may be used for descriptive purposes to describe the relationship of one element or feature to another element(s) or feature(s) as shown in the drawings. Spatially relative terms are intended to include, in addition to the orientations depicted in the drawings, different orientations in use, operation, and/or manufacture. For example, when a device shown in the drawings is inverted, elements depicted as being located "below" other elements or features are oriented "above" other elements or features. Thus, in an embodiment, the term "below" can include both up and down directions. Furthermore, the device may be oriented in other directions (e.g., rotated 90 degrees or otherwise), and the spatially relative terms used herein are to be interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Various embodiments will be described with reference to the drawings, which illustrate idealized embodiments. Accordingly, it is to be expected that the geometries may vary, for example, due to tolerances and/or manufacturing techniques. Accordingly, the embodiments disclosed herein should not be construed as being limited to the particular geometries shown, but should be construed to include changes in geometry that occur, for example, as a result of manufacturing. As such, the shapes illustrated in the drawings may not represent the actual shapes of the regions of the device, and the embodiments are not limited thereto.

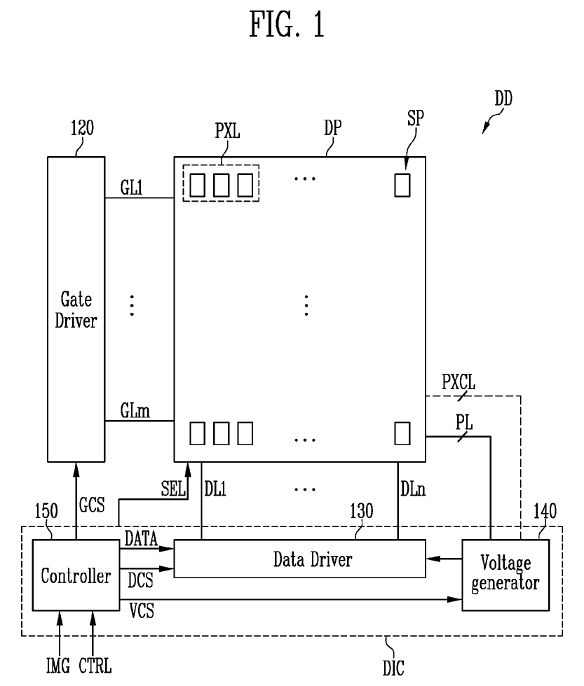

FIG. 1 is a block diagram illustrating an embodiment of a display device.

Referring to FIG. 1, an embodiment of the display device DD may include a display panel DP, a gate driver 120, a data driver 130, a voltage generator 140, and a controller 150.

The display panel DP includes sub-pixels SP. The sub-pixels SP may be connected to the gate driver 120 via first to m-th gate lines GL1 to GLm. The sub-pixel SP may be connected to the data driver 130 via first to n-th data lines DL1 to DLn. Here, n and ma are integers greater than 1.

The sub-pixels SP may generate light of two or more colors. In an embodiment, for example, each of the sub-pixels SP may generate light such as red, green, blue, cyan, magenta, yellow, etc.

Two or more of the sub-pixels SP may constitute a pixel PXL. In an embodiment, for example, the pixel PXL may include three sub-pixels as shown in FIG. 1. As such, the pixel PXL may emit light of various colors and various luminances depending on the combination of light emitted from the sub-pixels included therein.

The gate driver 120 is connected to the sub-pixels SP arranged in a row direction via the first to m-th gate lines GL1 to GLm. The gate driver 120 may output gate signals to the first to m-th gate lines GL1 to GLm in response to a gate control signal GCS. In embodiments, the gate control signal GCS may include a start signal indicating the start of each frame, a horizontal synchronization signal, and the like.

The gate driver 120 may be located on one side of the display panel DP. However, embodiments are not limited thereto. In another embodiment, for example, the gate driver 120 may be separated into two or more physically and/or logically distinct drivers, and the distinct drivers may be located on one side of the display panel DP and on an another side of the display panel DP opposite the one side, respectively. In such embodiments, the gate driver 120 may be located around the periphery of the display panel DP in various configurations according to embodiments.

According to embodiments, the gate driver 120 may be separated into a plurality of gate drivers. In an embodiment, for example, the gate driver 120 may be divided into a first gate driver including first gate lines, a second gate driver including second gate lines, and a third gate driver including third gate lines. However, for ease of description, drivers that operates as gate driver will be collectively referred to as a singular gate driver 120.

The data driver 130 is connected to the sub-pixels SP arranged in a column direction via the first to n-th data lines DL1 to DLn. The data driver 130 receives image data DATA and a data control signal DCS from the controller 150. The data driver 130 operates in response to the data control signal DCS. In embodiments, the data control signal DCS may include a source start signal, a source shift clock, a source output enable signal, and the like.

The data driver 130 may receive voltages from the voltage generator 140. Using the voltages from the voltage generator 140, the data driver 130 may apply data signals having grayscale voltages corresponding to the image data DATA to the first to n-th data lines DL1 to DLn. When a gate signal is applied to each of the first to m-th gate lines GL1 to GLm, data signals corresponding to the image data DATA may be applied to the data lines DL1 to DLn. Accordingly, the sub-pixels SP may generate light corresponding to the data signals, and the display panel DP may display an image.

In embodiments, the gate driver 120 and data driver 130 may include complementary metal-oxide semiconductor (CMOS) circuit elements.

The voltage generator 140 may operate in response to a voltage control signal VCS from the controller 150. The voltage generator 140 is configured to generate a plurality of voltages and provide the generated voltages to components of the display device DD, such as the gate driver 120, the data driver 130, and the controller 150. The voltage generator 140 may generate a plurality of voltages by receiving an input voltage from external to the display device DD and regulating the received voltage.

The voltage generator 140 may generate a first power supply voltage and a second power supply voltage. The generated first and second power supply voltages may be provided to the sub-pixels SP via power lines PL. In other embodiments, at least one of the first and second power supply voltages may be provided externally to the display device DD.

Additionally, the voltage generator 140 may provide a variety of voltages and/or signals. In an embodiment, for example, the voltage generator 140 may provide one or more initialization voltages that are applied to the sub-pixels SP. In an embodiment, for example, in a sensing operation to sense electrical characteristics of transistors and/or light emitting elements of the sub-pixels SP, a preset reference voltage may be applied to the first to n-th data lines DL1 to DLn and the voltage generator 140 may generate and transmit the reference voltage to the data driver 130. In an embodiment, for example, in a display operation to display an image on the display panel DP, a common set of pixel control signals may be applied to the sub-pixels SP, and the voltage generator 140 may generate the pixel control signals. In embodiments, the voltage generator 140 may provide the pixel control signals to the sub-pixels SP via pixel control lines PXCL. In an embodiment, as shown in FIG. 1, the pixel control lines PXCL may be connected between the voltage generator 140 and the display panel DP, but embodiments are not limited thereto. In an embodiment, for example, the pixel control lines PXCL may be connected between the gate driver 120 and the display panel DP. In such an embodiment, pixel control signals may be transmitted from the voltage generator 140 to the pixel control lines PXCL through the gate driver 120.

The controller 150 controls various operations of the display device DD. The controller 150 receives input image data IMG and a corresponding control signal CTRL from an external source. In response to the control signal CTRL, the controller 150 may provide the gate control signal GCS, the data control signal DCS, and the voltage control signal VCS.

The controller 150 may convert the input image data IMG to be suitable for the display device DD or the display panel DP and output the image data DATA. In embodiments, the controller 150 may output the image data DATA by arranging the input image data IMG to fit the sub-pixels SP on a row-by-row basis.

Two or more of the components of the data driver 130, the voltage generator 140, and the controller 150 may be mounted on or configured as a single integrated circuit (IC). In an embodiment, as shown in FIG. 1, the data driver 130, the voltage generator 140, and the controller 150 may be included in a driver IC DIC. In such an embodiment, the data driver 130, the voltage generator 140, and the controller 150 may be functionally distinct components within a single driver IC DIC.

The driver IC DIC may provide a select voltage SEL to the display panel DP. In an embodiment, the controller 150 may provide the select voltage SEL to the display panel DP. In another embodiment, the voltage generator 140 may provide the select voltage SEL to the display panel DP.

According to embodiments, at least one selected from the data driver 130, the voltage generator 140, and the controller 150 may be provided as a component separate from the driver IC DIC.

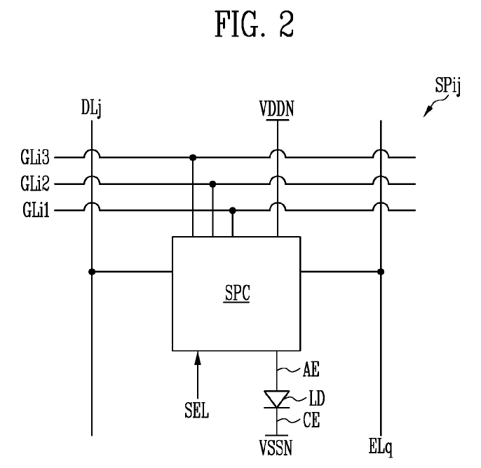

FIG. 2 is a block diagram illustrating an embodiment of one of sub-pixels of FIG. 1. In FIG. 2, a sub-pixel SPij of the sub-pixels SP of FIG. 1 arranged in an i-th row (where i is an integer greater than or equal to 1 and less than or equal to m) and a j-th column (where j is an integer greater than or equal to 1 and less than or equal to n) is illustrated as an example.

Referring to FIG. 2, an embodiment of the sub-pixel SPij may include a sub-pixel circuit SPC and a light emitting element LD.

The light emitting element LD is connected between a first power node VDDN and a second power node VSSN. The first power node VDDN is connected to one of the power lines PL of FIG. 1 to receive a first power supply voltage. The second power node VSSN is connected to another of the power lines PL of FIG. 1 to receive the second power supply voltage. The first power supply voltage may have a higher voltage level than the second power supply voltage.

The light emitting element LD is connected between an anode electrode AE and a cathode electrode CE. The anode electrode AE may be connected to the first power node VDDN via a sub-pixel circuit SPC. In an embodiment, for example, the anode electrode AE may be connected to the first power node VDDN via one or more transistors included in the sub-pixel circuit SPC. The cathode electrode CE may be connected to the second power node VSSN. The light emitting element LD is configured to emit light in response to a current flowing from the anode electrode AE to the cathode electrode CE.

The i-th gate lines GLi1, GLi2, and GLi3 may include a first gate line (or first i-th gate line) GLi1, a second gate line (or second i-th gate line) GLi2, and a third gate line (or third i-th gate line) GLi3. Each of the first gate line GLi1, the second gate line GLi2, and the third gate line GLi3 may receive different gate signals from each other. In an embodiment, for example, the first gate line GLi1 may receive a first gate signal, the second gate line GLi2 may receive a second gate signal, and the third gate line GLi3 may receive a third gate signal.

The sub-pixel circuit SPC may be connected to the i-th gate lines GLi1, GLi2, and GLi3 among the first to m-th gate lines GL1 to GLm of FIG. 1, and to a j data line DLj of the first to n-th data lines DL1 to DLn of FIG. 1. In response to gate signals received via the i-th gate lines GLi1, GLi2, and GLi3, the sub-pixel circuit SPC controls the light emitting element LD to emit light in accordance with the data signal received via the j-th data line DLj.

The power lines PL may include a plurality of emission lines. In an embodiment, the plurality of emission lines may include a q-th emission line ELq (where q is an integer greater than or equal to 1). The sub-pixel circuit SPC may be connected to the q-th emission line to receive an emission signal, and may control a time in which the light emitting element LD emits light, based on the emission signal. In an embodiment, for example, the light emitting element LD may emit light in response to an emission initiation signal included in the emission signal. However, this is merely an example and not limited thereto.

In embodiments, the sub-pixel circuit SPC may be further connected to the pixel control lines PXCL of FIG. 1. In such embodiments, the sub-pixel circuit SPC may further control the light emitting element LD in response to pixel control signals received via the pixel control lines PXCL.

For these operations, the sub-pixel circuit SPC may include circuit elements, such as transistors and one or more capacitors.

The transistors of the sub-pixel circuit SPC may include P-type transistors and/or N-type transistors. In embodiments, the transistors of the sub-pixel circuit SPC may include a metal oxide silicon field effect transistor (MOSFET). In embodiments, the transistors in the sub-pixel circuit SPC may include an amorphous silicon semiconductor, a monocrystalline silicon, polycrystalline silicon semiconductor, an oxide semiconductor, or the like.

The sub-pixel circuit SPC may be supplied with a select voltage SEL. In an embodiment, for example, the select voltage SEL output from the driver IC DIC (see FIG. 1) may be delivered to the sub-pixel circuit SPC.

In an embodiment, the select voltage SEL may be input to a gate electrode of a transistor included in the sub-pixel circuit SPC. The transistor may be turned on and/or turned off in response to the select voltage SEL.

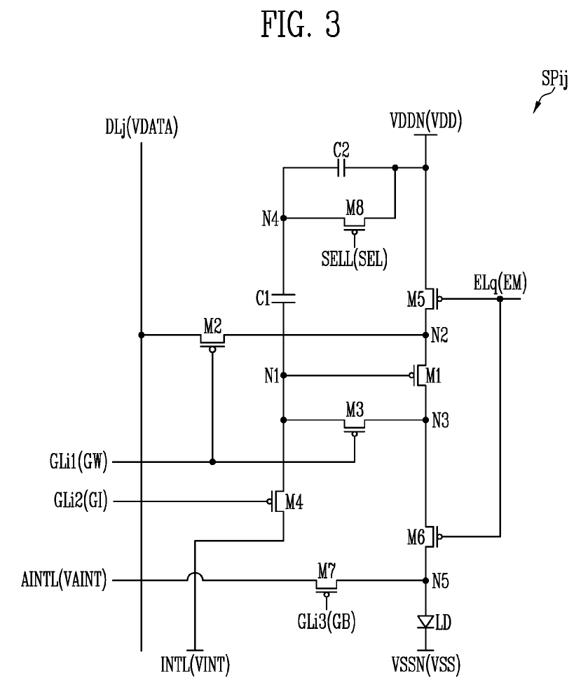

FIG. 3 is a circuit diagram to illustrate a sub-pixel according to an embodiment of the present disclosure.

Referring to FIG. 3, an embodiment of a sub-pixel SPij includes first to eighth transistors M1, M2, M3, M4, M5, M6, M7, and M8, first and second capacitors C1 and C2, and a light emitting element LD.

Hereinafter, an embodiment of a circuit including a P-type transistor will be described as an example. However, those skilled in the art will recognize that a circuit including an N-type transistor may be designed by varying the polarity of the voltage applied to the gate terminal. Similarly, those skilled in the art would be able to design a circuit including a combination of P-type transistors and N-type transistors. A P-type transistor refers to a transistor that increases current when the voltage difference between the gate and source electrodes increases in the negative direction. An N-type transistor is a transistor that increases the amount of current when the voltage difference between the gate and source electrodes increases in the positive direction. Transistors may be organized in various forms such as a thin film transistor (TFT), a field effect transistor (FET), a bipolar junction transistor (BJT), etc.

The first transistor M1 may include a gate electrode connected to a first node N1, a first electrode connected to a second node N2, and a second electrode connected to a third node N3. In an embodiment, for example, the first transistor M1 may operate as (or be referred to as) a drive transistor.

The second transistor M2 may include a gate electrode connected to a first gate line GLi1 through which a first gate signal GW is transmitted, a first electrode connected to a data line DLj through which a data voltage VDATA is transmitted, and a second electrode connected to the second node N2. In an embodiment, for example, the second transistor M2 may operate as (or be referred to as) a scan transistor.

The third transistor M3 may include a gate electrode connected to the first gate line GLi1, a first electrode connected to the first node N1, and a second electrode connected to the third node N3.

The fourth transistor M4 may include a gate electrode connected to a second gate line GLi2 through which a second gate signal GI is transmitted, a first electrode connected to the first node N1, and a second electrode connected to a first initialization line INTL through which a first initialization voltage VINT is supplied. In an embodiment, for example, the fourth transistor M4 may operate as (or be referred to as) a gate initialization transistor.

The fifth transistor M5 may include a gate electrode connected to a q-th emission line ELq through which an emission signal EM is transmitted, a first electrode connected to a first power node VDDN through which a first power supply voltage (or a first power source) VDD is transmitted, and a second electrode connected to the second node N2. In an embodiment, for example, the fifth transistor M5 may operate as (or be referred to as) a first emission transistor. In another embodiment, the gate electrode of the fifth transistor M5 may be connected to a different emission line.

The sixth transistor M6 may include a gate electrode connected to the q-th emission line ELq, a first electrode connected to the third node N3, and a second electrode connected to an anode electrode of the light emitting element LD (e.g., a fifth node N5). The sixth transistor M6 may operate as (or be referred to as) a second emission transistor. In another embodiment, the gate electrode of the sixth transistor M6 may be connected to a different emission line.

The seventh transistor M7 may include a gate electrode connected to a third gate line GLi3 through which a third gate signal GB is transmitted, a first electrode connected to a second initialization line AINTL through which a second initialization voltage VINT is supplied, and a second electrode connected to the anode electrode of the light emitting element LD (e.g., the fifth node N5). The seventh transistor M7 may operate as (or be referred to as) an anode initialization transistor. In another embodiment, the gate electrode of transistor M7 may be connected to another gate line.

The eighth transistor M8 may include a gate electrode connected to a select voltage line SELL carrying a select voltage SEL, a first electrode connected to the first power node VDDN, and a second electrode connected to a fourth node N4. In an embodiment, the eighth transistor M8 may be referred to as a switch transistor.

The first capacitor C1 may be connected between the first node N1 and the fourth node N4. The second capacitor C2 may be connected between the first power node VDDN and the fourth node N4. In an embodiment, the first capacitor C1 and the second capacitor C2 may be connected to each other in series.

The light emitting element LD may include the anode electrode connected to the second electrode of the sixth transistor M6 and a cathode electrode connected to a second power node VSSN which is supplied with a second power supply (or a second power source) VSS. According to an embodiment, the voltage level of the first power supply voltage VDD may be higher than that of the second power supply voltage VSS.

The light emitting element LD may include an organic light emitting diode, an inorganic light emitting diode, a quantum dot/well light emitting diode, or the like. The light emitting element LD may also include a plurality of light emitting diodes connected to each other in series, parallel, or series-parallel.

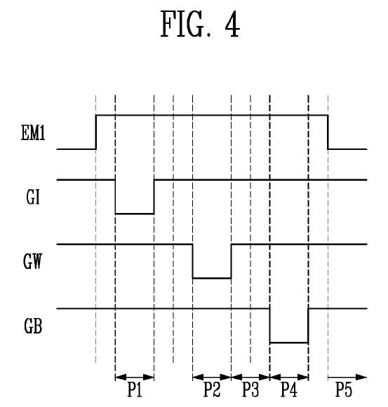

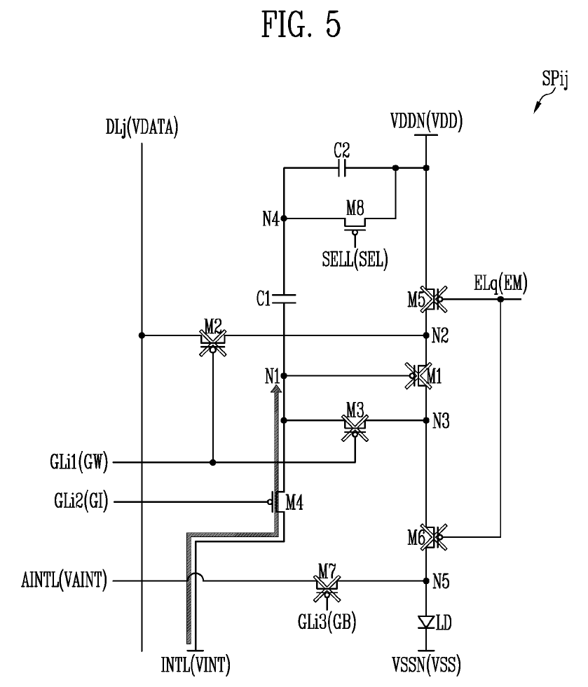

FIG. 4 is a signal timing diagram to illustrate the operation of the sub-pixel of FIG. 3. FIGS. 5-9 are circuit diagrams to illustrate the operation of the sub-pixel of FIG. 3.

Referring to FIG. 4, an embodiment of a first gate signal GW, a second gate signal GI, a third gate signal GB, and an emission signal EM are illustrated as an example. In an embodiment, the first gate signal GW, the second gate signal GI, the third gate signal GB, and the emission signal EM illustrated in FIG. 4 may be signals corresponding to a single frame. However, this is merely an example and not limited thereto.

Referring to FIGS. 3 and 4, the emission signal EM of a gate-off level (e.g., a logic high level) may be supplied to the q-th emission line ELq. In response to the emission signal EM of a gate-off level, the fifth transistor M5 and the sixth pixel transistor M6 may maintain a turn-off state.

Referring to FIGS. 4 and 5, in an embodiment, the second gate signal GI of a gate-on level (e.g., a logic low level) may be supplied to the second gate line GLi2 in a first period P1. In response to the second gate signal GI of the gate-on level, the fourth transistor M4 may remain in a turn-on state. Accordingly, the gate electrode (or, first node N1) of the first transistor M1 may be initialized to the first initialization voltage VINT. Accordingly, hysteresis of the first transistor M1 may be effectively prevented. According to an embodiment, the first period P1 may operate as (or be referred to as) an initialization period.

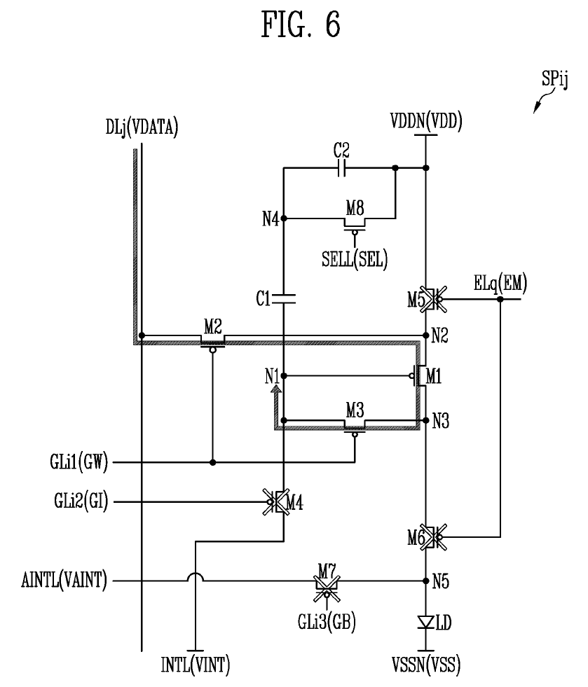

Referring to FIGS. 4 and 6, the first gate signal GW of a gate-on level (e.g., a logic low level) may be supplied to the first gate line GLi1 in a second period P2. In response to the first gate signal GW of the gate-on level, the second transistor M2 may remain in a turn-on state. Accordingly, the data voltage VDATA corresponding to a data signal may be transmitted to the second node N2, such that the data voltage VDATA may be applied to the first node N1 via the second node N2, the first transistor M1, the third node N3, and the third transistor M3.

According to an embodiment, when the eighth transistor M8 is turned off, the first capacitor C1 and the second capacitor C2 may be charged with a voltage corresponding to a potential difference between the first power supply voltage VDD and a voltage of the first node N1 according to their respective capacitance ratios.

When the eighth transistor M8 is turned on, the first capacitor C1 may be charged with a voltage corresponding to a potential difference between the first power supply voltages VDD and the voltage of the first node N1. When the eighth transistor M8 is turned on, the voltages at both ends of the second capacitor C2 may be equal to each other.

Further, a data voltage corresponding to the data signal may be delivered to a source electrode of the first transistor M1 (e.g., the second node N2) in the second period P2. At this time, the voltage of the first node N1 may be maintained to the first initialization voltage VINT.

Then, in the second period P2, in response to the first gate signal GW of a gate-on level, the third transistor M3 may be turned on. The third transistor M3 may be turned on to operate to maintain a voltage on a gate electrode of the first transistor M1 (e.g., the first node N1) constant. In an embodiment, for example, the third transistor M3 may be turned on to electrically connect the third node N3 and the first node N1 to each other. Accordingly, a value of difference between a gate electrode (e.g., the first node N1) and a source electrode (e.g., the second node N2) of the first transistor M1 may be constant, and compensation for the threshold voltage of the first transistor M1 may be achieved. According to an embodiment, during the operation of compensating the threshold voltage of the first transistor M1, the voltage of the first node N1 may rise. In an embodiment, for example, in the second period P2, the first transistor M1 may be turned on. Accordingly, the data voltage VDATA may be applied to the first node N1 via the second node N2, the first transistor M1, the third node N3, and the third transistor M3, causing the voltage at the first node N1 to rise.

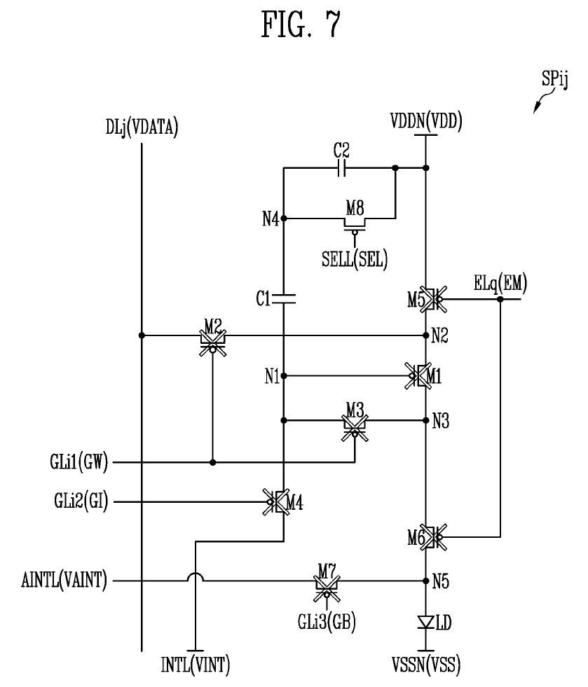

Referring to FIGS. 4 and 7, the first gate signal GW of a gate-off level (e.g., a logic high level) may be supplied to the first gate line GLi1 in a third period P3. In response to the first gate signal GW of the gate-off level, the third transistor M3 may be turned off, and the voltage of the first node N1 may rise. In an embodiment, for example, at a rising edge of the first gate signal GW, a kickback phenomenon may occur, causing the voltage of the first node N1 to rise.

According to an embodiment of the present disclosure, capacitors connected to the first node N1 and the kickback phenomenon may be used to control the voltage of the first node N1. In an embodiment, for example, the increase in the voltage of the first node N1 due to the kickback phenomenon may be inversely proportional to a value of capacitance of the capacitors connected to the first node N1. In other words, the increase in the voltage of the first node N1 due to the kickback phenomenon when the first node N1 is connected only with the first capacitor C1 may be less than the increase in the voltage of the first node N1 due to the kickback phenomenon when the first node N1 is connected with the first capacitor C1 and the second capacitor C2. Accordingly, the display device DD (see FIG. 1) may control the degree of increase of the voltage of the first node N1 by connecting the first node N1 and the first capacitor C1, or by connecting the first node N1 and the first and second capacitors C1 and C2. However, this is merely an example and not limited thereto.

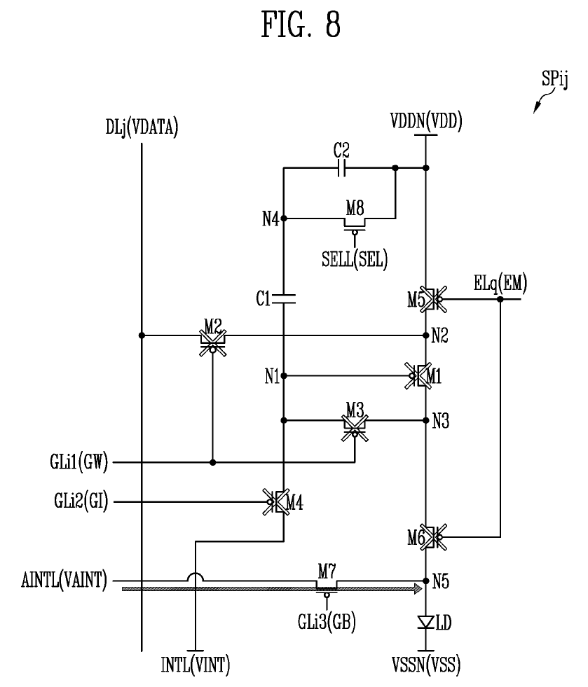

Referring to FIGS. 4 and 8, the third gate signal GB of a gate-on level (e.g., logic low level) may be supplied to the third gate line GLi3 in a fourth period P4. In response to the third gate signal GB of the gate-on level, the seventh transistor M7 may maintain the turn-on state. Accordingly, a first electrode (i.e., the anode electrode) of the light emitting element LD may be initialized to the second initialization voltage VAINT.

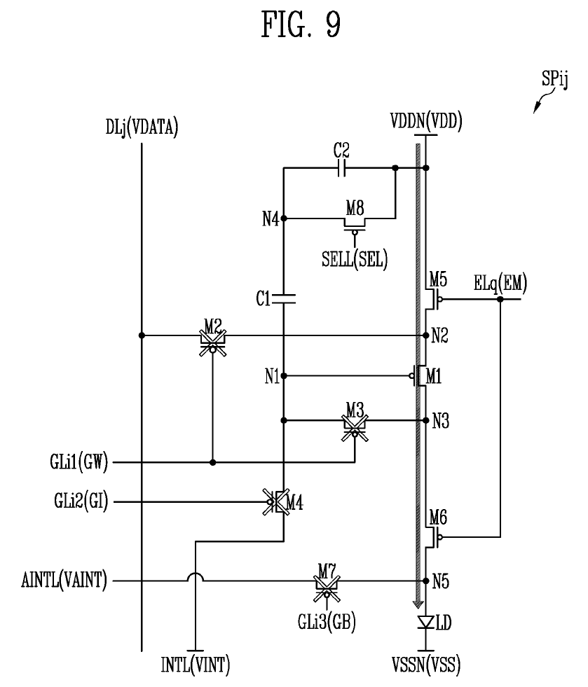

Referring to FIGS. 4 and 9, the emission signal EM of a gate-on level (e.g., a logic low level) may be supplied to the q-th emission line Elq in a fifth period P5. In response to the emission signal EM of the gate-on level, the fifth transistor M5 and the sixth transistor M6 may be maintained in a turn-on state. Accordingly, a current path connecting the first power supply voltage VDD, the fifth transistor M5, the first transistor M1, the sixth transistor M6, the light emitting element LD, and the second power supply voltage VSS is formed so that a driving current may flow.

A magnitude of the driving current may be set based on the voltage of the first node N1. In an embodiment, for example, the magnitude of the driving current may be proportional to a value of a voltage difference between the first power supply voltage VDD and the first node N1. Accordingly, in order to emit the sub-pixel SPij with high brightness, it is desired to increase the voltage difference between the first power supply voltage VDD and the first node N1. For example, in case that the voltage of the first node N1 is relatively reduced, the voltage difference between the first power supply voltage VDD and the first node N1 may be increased. Accordingly, light of a relatively high luminance may be output from the light emitting element LD.

According to an embodiment of the present disclosure, the display device DD (see FIG. 1) may turn on the eighth transistor M8 to output light with a relatively high brightness. In a case where only the first capacitor C1 is connected to the first node N1, the voltage difference between the first power supply voltage VDD and the first node N1 may be relatively higher than a case where the first node N1 is connected with the first and second capacitors C1 and C2. Accordingly, the display device DD may output relatively high brightness light through the light emitting element LD by turning on the eighth transistor M8 when outputting high brightness light is desired (e.g., in an outdoor environment).

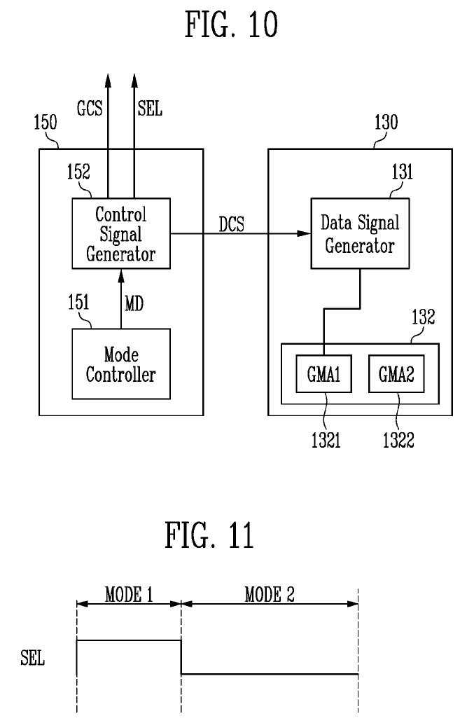

FIG. 10 is a block diagram illustrating a configuration of a controller and a data driver according to an embodiment of the present disclosure. FIG. 11 is a signal timing diagram showing a waveform of a select voltage of FIG. 10 according to a driving mode.

Referring to FIG. 10, in an embodiment, the controller 150 may include a mode controller 151 and a control signal generator 152.

The mode controller 151 may generate mode data MD corresponding to a driving mode of the sub-pixel SP (see FIG. 1) and provide the mode data MD to the control signal generator 152. In an embodiment, for example, the mode data MD may include first mode data and second mode data. The mode controller 151 may provide the first mode data to the control signal generator 152. The control signal generator 152 may generate a gate control signal GCS and a data control signal DCS that cause the sub-pixel SP to operate in the first mode. In addition, the mode controller 151 may provide the second mode data to the control signal generator 152. The control signal generator 152 may generate a gate control signal GCS and a data control signal DCS that cause the sub-pixel SP to operate in the second mode. In an embodiment, the first mode may be a normal driving mode, and the second mode may be a high brightness mode.

In an embodiment, the data driver 130 may include a data signal generator 131 and a lookup table 132.

The data signal generator 131 may be operable in response to a data control signal DCS. In an embodiment, for example, the data signal generator 131 may output data signals having grayscale voltages corresponding to the image data DATA (see FIG. 1) in response to the data control signal DCS.

The lookup table 132 may include a first gamma set (GAM1) 1321 and a second gamma set (GAM2) 1322 that is different from the first gamma set 1321. In this case, a gamma set may relate to grayscale values corresponding to the image data DATA and voltages of the data signal corresponding to each of the grayscale values.

The data signal generator 131 may optionally read a gamma set for a grayscale value corresponding to the image data DATA (see FIG. 1) from the lookup table 132. In an embodiment, for example, the data signal generator 131 may read out the first gamma set 1321 from the lookup table 132 based on the data control signal DCS. Accordingly, the data signal generator 131 may output a data signal corresponding to the first gamma set 1321 which is read out.

The control signal generator 152 may generate and output a select voltage SEL. In an embodiment, for example, the control signal generator 152 may transmit the select voltage SEL to the select voltage line SELL (see FIG. 3). In other words, the control signal generator 152 may transmit the select voltage SEL to the gate electrode of the eighth transistor M8 of the sub-pixel SPij (see FIG. 3).

In another embodiment, the voltage generator 140 (see FIG. 1) may generate the select voltage SEL. Hereinafter, for ease of description, embodiments where the controller 150 generates the select voltage SEL will be mainly described. In such an embodiment, for example, the control signal generator 152 included in the controller 150 may generate the select voltage SEL as shown in FIG. 10.

Referring to FIGS. 10 and 11, when the control signal generator 152 receives first mode data, the control signal generator 152 may generate the select voltage SEL of a logic high level. Accordingly, the sub-pixel SPij (see FIG. 3) operates in the first mode, and the eighth transistor M8 (see FIG. 3) may be turned off.

When the control signal generator 152 receives the second mode data, the control signal generator 152 may generate the select voltage SEL of a logic low level. Accordingly, the sub-pixel SPij operates in the second mode, and the eighth transistor M8 may be turned on.

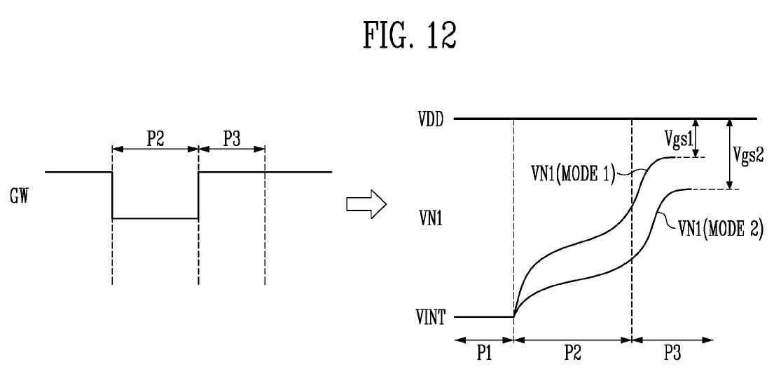

FIG. 12 is a diagram showing a voltage at a first node of a sub-pixel during a first period, a second period, and a third period according to an embodiment of the present disclosure.

In FIG. 12, a change in a voltage VN1 of the first node N1 of the sub-pixel SPij of FIG. 3 during the first period P1, the second period P2, and the third period P3 is schematically illustrated.

In addition, in FIG. 12, a waveform of the first gate signal GW is shown to represent a change in the voltage VN1 of the first node N1 according to the first gate signal GW. The first gate signal GW of FIG. 12 is the same as the first gate signal GW of FIG. 4, and may be described similarly. Further, the first gate signal GW of FIG. 12 may be a signal based on a gate control signal GCS (see FIG. 10).

Referring to FIG. 12, the voltage VN1 of the first node N1 may be maintained to the first initialization voltage VINT in the first period P1. In an embodiment, for example, in the first period P1, the first initialization voltage VINT may be input to the first node N1, and the voltage VN1 of the first node N1 may be maintained to the first initialization voltage VINT.

According to an embodiment, referring to FIGS. 6 and 12, during the second period P2, the first gate signal GW may have a gate-on level (e.g., a logic low level). During the second period P2, the second transistor M2, of which a gate electrode is supplied with the first gate signal GW, may be turned on, such that a data voltage VDATA may be supplied to the second node N2. Further, during the second period P2, the first transistor M1 and the third transistor M3 may be turned on, such that the data voltage VDATA may be supplied to the first node N1. Accordingly, the data voltage VDATA may be written to the capacitors. In other words, the second period P2 may be referred to as a data writing period.

According to an embodiment, in the second period P2, the second transistor M2 and the third transistor M3 may be turned on. At this time, the voltage of the first node N1 may be increased by the first transistor M1 which is diode-connected. In an embodiment, for example, during the second period P2, the third transistor M3 may be turned on, the first node N1 and the third node N3 may be electrically connected, and the voltage VN1 of the first node N1 may rise. Accordingly, compensation for the threshold voltage of the first transistor M1 may be performed. In other words, the second period P2 may also be referred to as a threshold voltage compensation period.

In the first mode MODE 1, the eighth transistor M8 may be turned off. Accordingly, the first node N1 may be connected to the first power node VDDN via the first capacitor C1 and the second capacitor C2. Accordingly, the first node N1 may be connected to both of the first capacitor C1 and the second capacitor C2.

In the second mode 2, the eighth transistor M8 may be turned on. Accordingly, the first node N1 may be connected to the first power node VDDN via the first capacitor C1 and the eighth transistor M8. In this case, the first node N1 may be directly connected to only the first capacitor C1.

According to an embodiment of the present disclosure, in the first mode MODE 1, the first capacitor C1 and the second capacitor C2 may be disposed between the first node N1 and the first power node VDDN. In such an embodiment, in a second mode MODE 2, the first capacitor C1 may be disposed between the first node N1 and the first power node VDDN. Accordingly, a capacitance value of the capacitors connected with the first node N1 in the second mode 2 may be greater than a capacitance value of the capacitors connected with the first node N1 in the first mode MODE 1. According to an embodiment of the present disclosure, the extent to which the voltage VN1 of the first node N1 rises in the second mode MODE 2 may be less than the extent to which the voltage VN1 of the first node N1 rises in the first mode MODE 1. Accordingly, in the second period P2, the voltage VN1 of the first node N1 in the second mode MODE 2 may be lower than the voltage VN1 of the first node N1 in the first mode MODE 1.

Referring to FIGS. 7 and 12, during the third period P3, the first gate signal GW may have a gate-off level (e.g., a logic high level). During the third period P3, the third transistor M3 may be turned off, and the first node N1 and the third node N3 may not be electrically connected. At this time, the voltage VN1 of the first node N1 may rise due to the kickback phenomenon of the third transistor M3.

According to an embodiment of the present disclosure, depending on the driving mode, the degree of change of the voltage VN1 of the first node N1 may be different. In an embodiment, for example, in the third period P3, the voltage VN1 of the first node N1 in the second mode MODE 2 may be lower than the voltage VN1 of the first node N1 in the first mode MODE 1. In an embodiment, for example, in second mode MODE 2, the eighth transistor M8 may be turned on, and the first node N1 may be connected with only the first capacitor C1. In first mode MODE 1, the eighth transistor M8 may be turned off, and the first node N1 may be connected with both the first capacitor C1 and the second capacitor C2. In other words, a capacitance value of the capacitors connected with the first node N1 in the second mode MODE 2 may be greater than a capacitance value of the capacitors connected with the first node N1 in the first mode MODE 1. In this case, the degree of change of the voltage VN1 of the first node N1 due to the kickback phenomenon may be inversely proportional to the capacitance value of the capacitors connected with the first node N1. Accordingly, the extent to which the voltage VN1 of the first node N1 increases in the second mode MODE 2 may be less than the extent to which the voltage VN1 of the first node N1 increases in the first mode MODE 1. Accordingly, in the third period P3, the voltage VN1 of the first node N1 in the second mode MODE 2 may be lower than the voltage VN1 of the first node N1 in the first mode MODE 1.

In an embodiment, the voltage VN1 of the first node N1 may be maintained in a period after the third period P3. In an embodiment, for example, the voltage VN1 of the first node N1 that has risen due to the kickback phenomenon in the third period P3 may be maintained in the fourth period P4 (see FIG. 4) and the fifth period P5 (see FIG. 4).

Referring to FIGS. 4 and 12, in the first mode MODE 1, a difference value between a gate electrode and a source electrode of the first transistor M1 (see FIG. 3) may be a first gate source voltage Vgs1. In an embodiment, for example, when the light emitting current flows to the first transistor M1 in the fifth period P5, the second node N2 may be connected with the first power supply voltage VDD. Furthermore, the voltage VN1 of the first node N1 may be maintained until the fifth period P5, which is after the third period P3. Accordingly, in the first mode MODE 1, the first gate source voltage Vgs1 may have a difference value between the first power supply voltage VDD and the voltage VN1 of the first node N1, and the sub-pixel SPij (see FIG. 3) may output light having a luminance proportional to the first gate source voltage Vgs1.

Further, in the second mode MODE 2, the difference value between a gate electrode and a source electrode of the first transistor M1 may be a second gate source voltage Vgs2. In an embodiment, for example, when the light emitting current flows to the first transistor M1, the second node N2 may be connected with the first power supply voltage VDD. Accordingly, the second gate source voltage Vgs2 may have a difference value between the first power supply voltage VDD and the voltage VN1 of the first node N1. Further, the voltage VN1 of the first node N1 may be maintained until the fifth period P5, which is after the third period P3. Accordingly, in the second mode MODE 2, the second gate source voltage Vgs2 may have a difference value between the first power supply voltage VDD and the voltage VN1 of the first node N1, and the sub-pixel SPij (see FIG. 3) may output light of a luminance proportional to the second gate source voltage Vgs2.

According to an embodiment of the present disclosure, the display device DD (see FIG. 1) may adaptively control the luminance of the light output by the sub-pixel SPij. In an embodiment, for example, the second gate source voltage Vgs2 may be greater than the first gate source voltage Vgs1. The luminance of the light output by the sub-pixel SPij in the second mode MODE 2 may be higher than the luminance of the light output by the sub-pixel SPij in the first mode MODE 1. Accordingly, the display device DD may operate the sub-pixel SPij in the second mode MODE 2 in order to express a high luminance image.

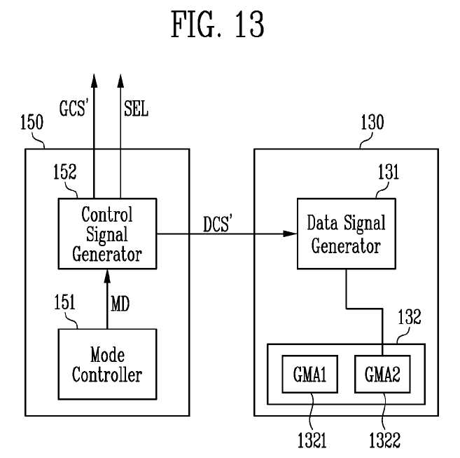

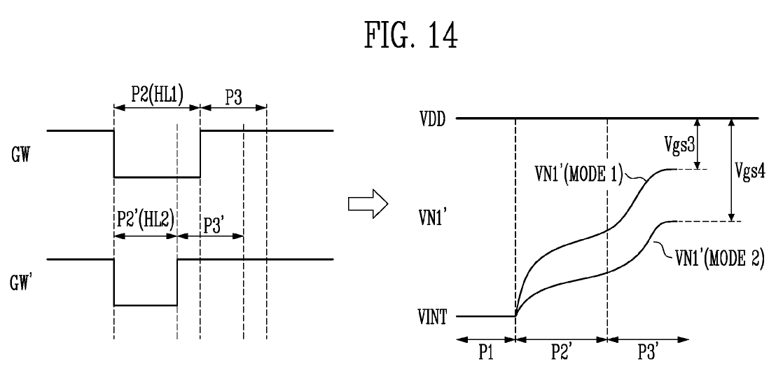

FIG. 13 is a block diagram to illustrate the operation of a controller and a data driver according to another embodiment of the present disclosure. FIG. 14 is a diagram showing a voltage at a first node of a sub-pixel during a first period, a second period, and a third period according to another embodiment of the present disclosure.

Referring to FIG. 13, in an embodiment, the controller 150 may include a mode controller 151 and a control signal generator 152. In such an embodiment, the data driver 130 may include a data signal generator 131 and a lookup table 132.

The mode controller 151 and the control signal generator 152 of FIG. 13 may be the same as or similar to the mode controller 151 and the control signal generator 152 of FIG. 10 described above. The data signal generator 131 and the lookup table 132 of FIG. 13 may be the same as or similar to the data signal generator 131 and the lookup table 132 of FIG. 10. Hereinafter, any repetitive detailed descriptions thereof will be omitted.

FIG. 14 illustrates a waveform of a first gate signal GW' to represent a change in the voltage VN1' of the first node N1 in response to the first gate signal GW'.

A first gate signal GW of FIG. 14 may be similar to the first gate signal GW of FIG. 12. In an embodiment, for example, the first gate signal GW may be generated based on the gate control signal GCS of FIG. 10. Further, the first gate signal GW' may be generated based on a gate control signal GCS' of FIG. 13.

The first gate signal GW may include a second period P2 and a third period P3. The second period P2 may have a first horizontal length HL1. In an embodiment, for example, the first gate signal GW may be kept at a low level by the first horizontal length HL1.

Referring to FIGS. 13 and 14, in an embodiment, the control signal generator 152 may output a gate control signal GCS’. In an embodiment, for example, the gate driver 120 (see FIG. 1) may output the first gate signal GW' based on the gate control signal GCS'. In other words, the gate driver 120 may decrease the scan on time (SOT) of the first gate signal GW’ based on the gate control signal GCS’. In an embodiment, for example, the gate driver 120 may vary a horizontal length of the first gate signal GW' from the first horizontal length HL1 to a second horizontal length HL2 based on the gate control signal GCS'. The scan on time (SOT) may refer to a time during which the first gate signal GW' has a gate-on signal (or logic low level).

According to an embodiment, the controller 150 may operate to decrease the SOT of the first gate signal GW' in the second mode. In an embodiment, for example, the mode controller 151 may provide the second mode data to the control signal generator 152. The control signal generator 152 may provide the gate control signal GCS’ to the gate driver 120 (see FIG. 1), and the gate driver 120 may output the first gate signal GW’ with a reduced SOT. Accordingly, the sub-pixel SPij (see FIG. 3) may be operated to output a relatively higher luminance light based on the first gate signal GW’.

The first gate signal GW' may include a first period P1, a second period P2’, and a third period P3’. The first period P1 of FIG. 14 may be similar to the first period P1 of FIG. 12. Hereinafter, any repetitive detailed descriptions thereof will be omitted.

The second period P2' may have a second horizontal length HL2. In an embodiment, for example, the first gate signal GW' may be kept at a low level for the second horizontal length HL2. The second horizontal length HL2 may be shorter than the first horizontal length HL1.

According to an embodiment, a horizontal length of the third period P3' of FIG. 14 may be the same as a horizontal length of the third period P3 of FIG. 12. In an embodiment, for example, the first gate signal GW' and the first gate signal GW may differ in horizontal length only in the second period, and may have the same horizontal length in the remaining periods. Accordingly, the overall horizontal length of one frame of the first gate signal GW' may be shorter than the overall horizontal length of one frame of the first gate signal GW. However, this is merely an example and not limited thereto.

According to another embodiment, a horizontal length of the third period P3' of FIG. 14 may be longer than a horizontal length of the third period P3 of FIG. 12. In an embodiment, for example, the horizontal length of the third period P3' of FIG. 14 may be longer than the horizontal length of the third period P3 of FIG. 12 as the second horizontal length HL2 is shorter than the first horizontal length HL1. Accordingly, the overall horizontal length of one frame of the first gate signal GW' may be the same as the overall horizontal length of one frame of the first gate signal GW.

According to an embodiment, referring to FIGS. 6 and 14, during the second period P2', the first gate signal GW' may have a gate-on level (e.g., a logic low level). During the second period P2', the second transistor M2, of which a gate electrode is supplied with the first gate signal GW', may be turned on, such that a data voltage VDATA may be supplied to the second node N2. Further, during the second period P2, the first transistor M1 and the third transistor M3 may be turned on, such that the data voltage VDATA may be supplied to the first node N1. Accordingly, the data voltage VDATA may be written to the capacitors. In other words, the second period P2' may be referred to as the data writing period.

According to an embodiment, in the second period P2', the second transistor M2 and the third transistor M3 may be turned on. At this time, the voltage of the first node N1 may be increased by the first transistor M1 which is diode-connected. For example, during the second period P2', the third transistor M3 may be turned on, the first node N1 and the third node N3 may be electrically connected, and the voltage VN1 of the first node N1 may rise. Accordingly, compensation for the threshold voltage of the first transistor M1 may be performed. In other words, the second period P2' may also be referred to as a threshold voltage compensation period.

The horizontal length of the second period P2' of FIG. 14 may be shorter than the horizontal length of the second period P2 of FIG. 12. In an embodiment, for example, the second horizontal length HL2 may be shorter than the first horizontal length HL1. Accordingly, the extent to which the voltage VN1' of the first node N1 increases during the second period P2' may be less than the extent to which the voltage VN1 of the first node N1 (see FIG. 12) increases during the second period P2. In other words, the voltage VN1’ of the first node N1 in the second period P2’ may be lower than the voltage VN1 of the first node N1 in the second period P2.

Referring to FIGS. 6 and 14, in the second period P2', the voltage VN1' of the first node N1 in the second mode MODE 2 may be lower than the voltage VN1' of the first node N1 in the first mode MODE 1. In an embodiment, for example, in the second mode MODE 2, the eighth transistor M8 may be turned on, and the first node N1 may be connected only with the first capacitor C1. In the first mode MODE 1, the eighth transistor M8 is turned off, and the first node N1 may be connected with both the first capacitor C1 and the second capacitor C2. In other words, a capacitance value of the capacitors connected with the first node N1 in the second mode MODE 2 may be greater than a capacitance value of the capacitors connected with the first node N1 in the first mode MODE 1. The extent to which the voltage VN1' of the first node N1 rises in the second mode MODE 2 may be less than the extent to which the voltage VN1' of the first node N1 rises in the first mode MODE 1. Accordingly, in the second period P2', the voltage VN1' of the first node N1 in the second mode MODE 2 may be lower than the voltage VN1' of the first node N1 in the first mode MODE 1.

Referring to FIGS. 7 and 14, during the third period P3', the first gate signal GW' may have a gate-off level (e.g., a logic high level). During the third period P3', the third transistor M3 may be turned off, and the first node N1 and the third node N3 may not be electrically connected. At this time, the voltage VN1' of the first node N1 may rise due to the kickback phenomenon of the third transistor M3.

Depending on the driving mode, the degree of change of the voltage VN1' of the first node N1 may vary. In an embodiment, for example, in the third period P3', the voltage VN1' of the first node N1 in the second mode MODE 2 may be lower than the voltage VN1' of the first node N1 in the first mode MODE 1. In an embodiment, for example, in the second mode MODE 2, the eighth transistor M8 may be turned on, and the first node N1 may be connected only with the first capacitor C1. In the first mode MODE 1, the eighth transistor M8 may be turned on, and the first node N1 may be connected with both the first capacitor C1 and the second capacitor C2. In other words, a capacitance value of the capacitors connected with the first node N1 in the second mode MODE 2 may be greater than a capacitance value of the capacitors connected with the first node N1 in the first mode MODE 1. In this case, the degree of change of the voltage VN1' of the first node N1 due to the kickback phenomenon may be inversely proportional to the capacitance value of the capacitors connected with the first node N1. Accordingly, the extent to which the voltage VN1' of the first node N1 increases in the second mode MODE 2 may be less than the extent to which the voltage VN1' of the first node N1 increases in the first mode MODE 1. Accordingly, the voltage VN1’ of the first node N1 in the second mode MODE 2 at the third period P3’ may be lower than the voltage VN1’ of the first node N1 in the first mode MODE 1.

In an embodiment, the voltage VN1' of the first node N1 may be maintained in a period after the third period P3'. In an embodiment, for example, the voltage VN1’ of the first node N1 that has risen due to the kickback phenomenon in the third period P3 may be maintained in the fourth period P4 (see FIG. 4) and the fifth period P5 (see FIG. 4).

Referring to FIGS. 4 and 14, in the first mode MODE 1, the difference value between a gate electrode and a source electrode of the first transistor M1 (see FIG. 3) may be a third gate source voltage Vgs3. In an embodiment, for example, when the light emitting current flows to the first transistor M1 in the fifth period P5, the second node N2 may be connected to the first power supply voltage VDD. Furthermore, the voltage VN1' of the first node N1 may be maintained until the fifth period P5, which is after the third period P3'. Accordingly, in the first mode MODE 1, the third gate source voltage Vgs3 may have a difference value between the first power supply voltage VDD and the voltage VN1’ of the first node N1, and the sub-pixel SPij (see FIG. 3) may output light of a luminance proportional to the third gate source voltage Vgs3.

Further, in the second mode MODE 2, the difference value between the gate electrode and the source electrode of the first transistor M1 may be a fourth gate source voltage Vgs4. In an embodiment, for example, when the light emitting current flows to the first transistor M1, the second node N2 may be connected to the first power supply voltage VDD. Accordingly, the fourth gate source voltage Vgs4 may have a difference value between the first power supply voltage VDD and the voltage VN1' of the first node N1. Further, the voltage VN1' of the first node N1 may be maintained until the fifth period P5, which is after the third period P3'. Accordingly, in the second mode MODE 2, the fourth gate source voltage Vgs4 may have a difference value between the first power supply voltage VDD and the voltage VN1’ of the first node N1, and the sub-pixel SPij (see FIG. 3) may output light of a luminance proportional to the fourth gate source voltage Vgs4.

According to an embodiment of the present disclosure, the controller 150 may control the sub-pixel to output light of a relatively higher luminance by decreasing the horizontal length of the first gate signal. In an embodiment, for example, the controller 150 may decrease the horizontal length of the second period P2' in the second mode from the first horizontal length HL1 to the second horizontal length HL2. Accordingly, the extent to which the voltage VN1' of the first node N1 increases during the second period P2' and the third period P3' may be less than the extent to which the voltage VN1 (see FIG. 12) of the first node N1 increases during the second period P2 and the third period P3. Accordingly, the fourth gate source voltage Vgs4 may be greater than the second gate source voltage Vgs2 (see FIG. 12). In the second mode, the sub-pixel operating in response to the first gate signal GW' may output light of a relatively higher luminance.

Referring to FIGS. 13 and 14, the control signal generator 152 may output a data control signal DCS’ to the data signal generator 131.

The data signal generator 131 may operate in response to the data control signal DCS’. In an embodiment, for example, the data signal generator 131 may output data signals having a gradient voltage corresponding to the image data DATA (see FIG. 1) in response to the data control signal DCS’.

The data signal generator 131 may read out a gamma set of the grayscale values corresponding to the image data DATA (see FIG. 1) from a lookup table 132. In an embodiment, for example, the data signal generator 131 may read out a second gamma set 1322 from the lookup table 132 based on the data control signal DCS’. The data signal generator 131 may output a data signal corresponding to the second gamma set 1322 which is read out.

Referring to FIGS. 13 and 14, the data signal generator 131 may read out the first gamma set 1321 from the lookup table 132 when the second period P2 has the first horizontal length HL1. Accordingly, the data signal generator 131 may output a data signal corresponding to the first gamma set 1321.

Further, the data signal generator 131 may read out the second gamma set 1322 from the lookup table 132 when the second period P2 has a second horizontal length HL2. Accordingly, the data signal generator 131 may output a data signal corresponding to the second gamma set 1322.

According to embodiments, the first gamma set 1321 may relate to the grayscale values corresponding to the image data and the voltages of the data signal corresponding to each of the grayscale values when the second period P2 has the first horizontal length HL1. According to embodiments, the second gamma set 1322 may relate to the grayscale values corresponding to the image data and the voltages of the data signals corresponding to each of the grayscale values when the second period P2' has the second horizontal length HL2.

According to an embodiment of the present disclosure, the data signal generator 131 may generate the data signal by selectively reading out either the first gamma set 1321 or the second gamma set 1322 from the lookup table 132.

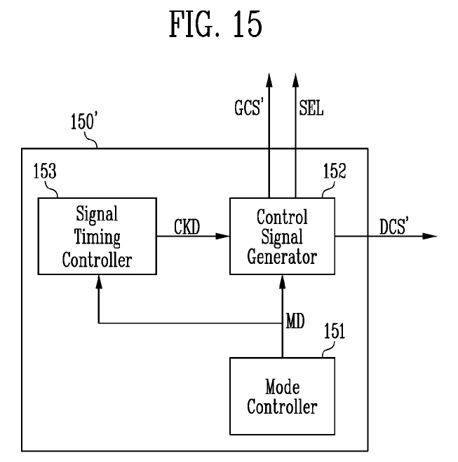

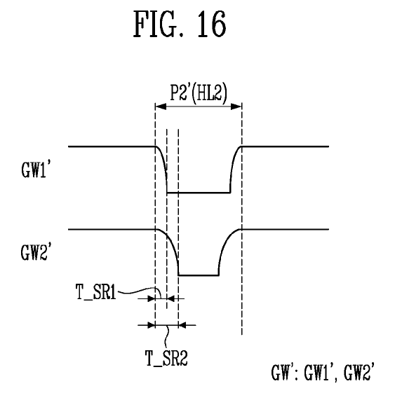

FIG. 15 is a block diagram illustrating a controller according to another embodiment of the present disclosure. FIG. 16 is a signal timing diagram illustrating the principle of operation of a signal timing controller of FIG. 15.

Referring to FIG. 15, in an embodiment, the controller 150' may include a mode controller 151, a control signal generator 152, and a signal timing controller 153.

The mode controller 151 and the control signal generator 152 of FIG. 15 may be substantially the same as or similar to the mode controller 151 and the control signal generator 152 of FIG. 10. Hereinafter, any repetitive detailed descriptions thereof will be omitted.

In FIG. 16, a first first gate signal (hereinafter, will be referred to as “1_1-th gate signal”) GW1' and a second first gate signal (hereinafter, will be referred to as “1_2-th gate signal”) GW2' based on a gate control signal GCS’ are shown in relation to a second period P2’. The first gate signals GW1' and GW2' of FIG. 16 may be embodiments of the first gate signal GW’ of FIG. 14. Additionally, the second period P2' of FIG. 16 may be the same as the second period P2' of FIG. 14. In an embodiment, for example, the first gate signals GW' of FIG. 16 may be gate signals with a reduced scan on time (SOT) to be less than that of the first gate signal GW (see FIG. 14).

The signal timing controller 153 may control a slew rate of the gate signals. In an embodiment, for example, the signal timing controller 153 may generate clock timing data CKD. The signal timing controller 153 may output the clock timing data CKD to the control signal generator 152. The control signal generator 152 may generate a gate control signal GCS’ based on the clock timing data CKD. The gate driver 120 (see FIG. 1) may generate a gate signal (e.g., a first gate signal) based on the gate control signal GCS’. Accordingly, a slew rate of the gate signal may be controlled in response to the gate control signal GCS' based on clock timing data CKD.

The slew rate may be defined as the amount of change in voltage (or signal level) per unit time. In an embodiment, for example, the slew rate may refer to a rate at which a voltage of the gate signal changes in response to the gate control signal GCS'.

Referring to FIGS. 15 and 16, in the second period P2', the 1_1-th gate signal GW1' may transition from a high level to a low level. The time taken for the 1_1-th gate signal GW1' to transition from the high level to the low level may be a first transition period T_SR1.

In the second period P2', the 1_2-th gate signal GW2' may transition from a high level to a low level. The time taken for the 1_2-th gate signal GW2' to transition from the high level to the low level may be a second transition period T_SR2.

Referring to FIGS. 14 and 16, according to an embodiment, in cast that the second period P2' has a second horizontal length HL2, the display device DD (see FIG. 1) may reduce the slew rate of the gate signal, so that the sub-pixel SP (see FIG. 1) outputs light of a relatively higher luminance. In an embodiment, for example, the slew rate of the 1_2-th gate signal GW2' may be less than the slew rate of the 1_1-th gate signal GW1'. In an embodiment, for example, the second transition period T_SR2 may be longer than the first transition period T_SR1. The less the slew rate of the gate signal, the longer it may take for the level of the gate signal to change in the second period P2'. Accordingly, in the second period P2’, the change in the voltage VN1' (see FIG. 14) of the first node N1 may be relatively small. According to an embodiment of the present disclosure, the display device DD may reduce the slew rate of the first gate signal GW' so that the sub-pixel SP may output light of a relatively higher brightness.

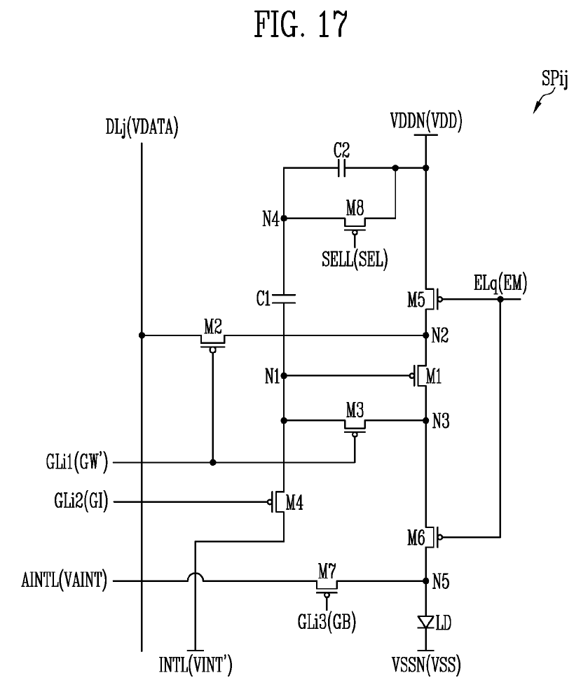

FIG. 17 is a drawing to illustrate a pixel according to another embodiment of the present disclosure.

Referring to FIG. 17, an embodiment of the sub-pixel SPij includes first to eighth transistors M1, M2, M3, M4, M5, M6, M7, and M8, first and second capacitors C1 and C2, and a light emitting element LD. The first to eighth transistors M1, M2, M3, M4, M5, M6, M7, and M8, the first and second capacitors C1 and C2, and the light emitting element LD of FIG. 17 may be the same as or similar to the first to eighth transistors M1, M2, M3, M4, M5, M6, M7, and M8, the first and second capacitors C1 and C2, and the light emitting element LD of FIG. 3. Hereinafter, any repetitive detailed descriptions thereof will be omitted.

Referring to FIG. 17, in an embodiment, the second transistor M2 may have a gate electrode connected to the first gate line GLi1 that transfers the first gate signal GW', a first electrode connected to the data line DLj that transfers the data voltage VDATA, and a second electrode connected to the second node N2. In an embodiment, for example, the second transistor M2 may operate as (or be referred to as) a scan transistor.

The first gate signal GW' of FIG. 17 may be a gate signal having a reduced scan on time (SOT) than the first gate signal GW (see FIG. 14).

The third transistor M3 may have a gate electrode connected to the first gate line GLi1 that transfers the first gate signal GW', a first electrode connected to the first node N1, and a second electrode connected to the third node N3.

The fourth transistor M4 may have a gate electrode connected to the second gate line GLi2 that transfers the second gate signal GI, a first electrode connected to the first node N1, and a second electrode connected to the first initialization line INTL that transfers the first initialization voltage VINT'.

Referring to FIGS. 14 and 17, in an embodiment, in case that the second period P2' of the first gate signal GW' has a second horizontal length HL2, the display device DD (see FIG. 1) may reduce the first initialization voltage such that the sub-pixel SP (see FIG. 1) outputs light of a relatively higher luminance. In an embodiment, for example, the first initialization voltage VINT' of FIG. 17 may be a less value than the first initialization voltage VINT of FIG. 3. The sub-pixel SPij may cause the light emitting element LD to emit light at a luminance corresponding to a difference value between the first power supply voltage VDD and the voltage of the first node N1. At this time, the first node N1 may be input with the first initialization voltage VINT' having a relatively small value. When the voltage of the first node N1 increases from the first initialization voltage VINT', the voltage of the first node N1 may have a relatively small value in the third period P3. Accordingly, the difference between the voltage of the first power supply voltage VDD and the voltage of the first node N1 may increase relatively. According to an embodiment of the present disclosure, the display device DD may reduce the magnitude of the first initialization voltage VINT' so that the sub-pixel SPij may output light with a relatively higher luminance.

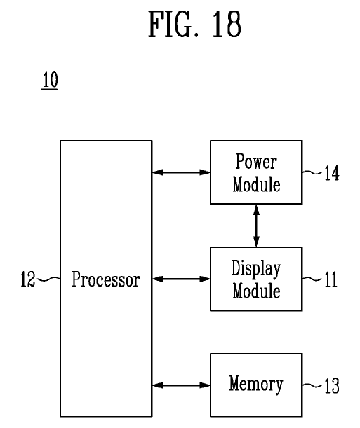

FIG. 18 is a block diagram of an electronic device according to an embodiment.

Referring to FIG. 18, the electronic device 10 according to an embodiment may include a display module 11, a processor 12, a memory 13, and a power module 14.

The processor 12 may include at least one selected from a central processing unit (CPU), an application processor (AP), a graphic processing unit (GPU), a communication processor (CP), an image signal processor (ISP), and a controller.

In an embodiment, the processor 12 may operate similarly to the driver IC DIC of FIG. 1. However, this is merely an example and not limited thereto.

The memory 13 may store data information used for operation of the processor 12 or the display module 11. When the processor 12 executes an application stored in the memory 13, image data signals and/or input control signals are delivered to the display module 11, and the display module 11 may process the signals provided and output image information via the display screen.

The power module 14 may include a power supply module, such as a power adapter or a battery unit, and a power conversion module that converts the power supplied by the power supply module to generate the power used for operation of the electronic device 10.

At least one of each of the above-described configurations of the electronic device 10 may be included within the display device according to the above-described embodiments. Furthermore, some of the individual modules that are functionally included within one module may be included within the display device and others may be provided separately from the display device. In an embodiment, for example, the display device may include the display module 11, while the processor 12, the memory 13, and the power module 14 may be provided in the form of other devices within the electronic device 10 other than the display device.

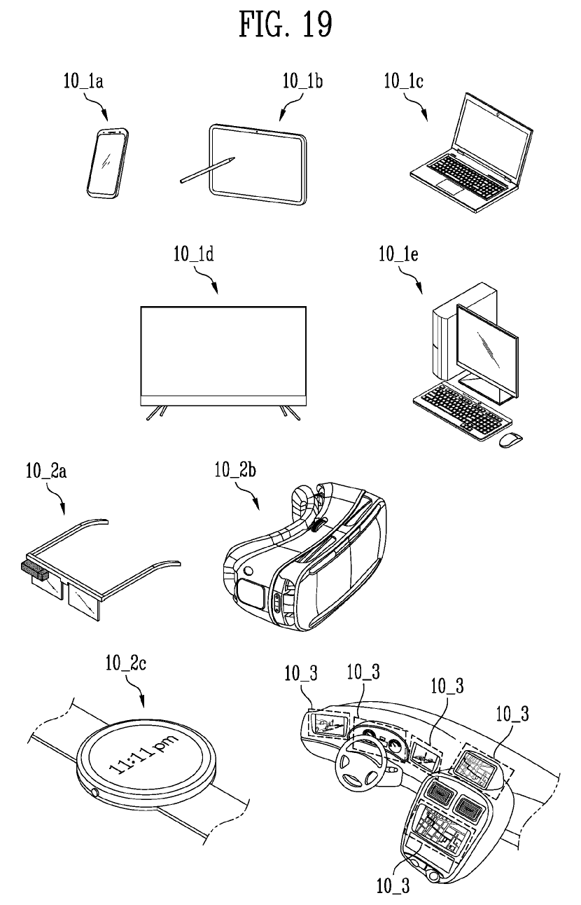

FIG. 19 is a schematic diagram of an electronic device according to various embodiments.

Referring to FIG. 19, various electronic devices with a display device according to embodiments include an electronic device for displaying images, such a as a smartphones 10_1a, a tablet personal computer (PC) 10_1b, a laptop computer 10_1c, a television 10_1d, a desk monitor 10_1e, as well as a wearable electronic device including a display module such as a smart glasses 10_2a, a head-mounted display 10_2b, a smart watch 10_2c, and the like, and an automotive electronic device 10_3 including a display module such as a center information display (CID), a room mirror display, and the like disposed on an instrument panel, a center fascia, or a dashboard of an automobile.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A pixel comprising:
a light emitting element connected between a first power node and a second power node;
a first transistor which controls an amount of light emitting current flowing from the first power node to the second power node via the light emitting element based on a voltage of a first node;
a first capacitor connected between the first node and a fourth node;
a second capacitor connected between the fourth node and the first power node; and
a switch transistor connected between the first power node and the fourth node and including a gate electrode connected to a select power line.

2. The pixel of claim 1, wherein, in a first mode, the switch transistor is in a turn-off state, and
wherein, in a second mode, the switch transistor is in a turn-on state.

3. The pixel of claim 2, further comprising:
a second transistor including a first electrode connected to a data line, a second electrode connected to the second node, and a gate electrode connected to a first gate line;
a third transistor including a first electrode connected to a third node, a second electrode connected to the first node, and a gate electrode connected to the first gate line; and
a fourth transistor including a first electrode connected to the first node, a second electrode connected to a first initialization line, and a gate electrode connected to a second gate line.

4. The pixel of claim 3, wherein a horizontal period of a frame includes a first period, a second period, and a third period,
wherein, during the first period, the fourth transistor is in a turn-on state,
wherein, during the second period, the first transistor, the second transistor, and the third transistor are in a turn-on state, and
wherein, during the third period, the second transistor and the third transistor are in the turn-off state.

5. The pixel of claim 4, wherein, in the third period, a voltage of the first node in the second mode is lower than a voltage of the first node in the first mode.

6. The pixel of claim 3, further comprising:
a fifth transistor including a first electrode connected to the first power node, a second electrode connected to a second node, and a gate electrode connected to an emission line;
a sixth transistor including a first electrode connected to the third node, a second electrode connected to a fifth node, and a gate electrode connected to the emission line; and
a seventh transistor including a first electrode connected to the fifth node, a second electrode connected to a second initialization line, and a gate electrode connected to a third gate line.

7. The pixel of claim 1, wherein the first capacitor and the second capacitor are connected to each other in series.

8. The pixel of claim 1, wherein the switch transistor is a P-type transistor.

9. A display device comprising:
pixels connected to gate lines, emission control lines, and data lines;
a gate driver which drives the gate lines; and
a driver integrated circuit which supplies a control signal to the gate driver,
wherein a pixel of the pixels includes:
a light emitting element connected between a first power node and a second power node;
a first transistor which controls an amount of light emitting current flowing from the first power node to the second power node via the light emitting element based on a voltage of a first node;
a first capacitor connected between the first node and a fourth node;
a second capacitor connected between the fourth node and the first power node; and
a switch transistor connected between the first power node and the fourth node and including a gate electrode connected to a select power line supplied with a select voltage.

10. The display device of claim 9, wherein the driver integrated circuit turns off the switch transistor in a first mode and turns on the switch transistor in a second mode via the select voltage.

11. The display device of claim 10, wherein the gate driver supplies a first gate line of the gate lines with a first gate signal including a first period, a second period, and a third period based on the control signal,
wherein, when changed from the first period to the second period, the first gate signal is transitioned from a high level to a low level, and
wherein, when changed from the second period to the third period, the first gate signal is transitioned from a low level to a high level.

12. The display device of claim 11, wherein, in the second mode, the gate driver changes a horizontal length of the second period of the first gate signal from a first horizontal length to a second horizontal length, and
wherein the second horizontal length is shorter than the first horizontal length.

13. The display device of claim 12, wherein a voltage of the first node during the third period when the second period has the second horizontal length, is less than a voltage of the first node during the third period when the second period has the first horizontal length.

14. The display device of claim 12, wherein the driver integrated circuit includes:
a data driver that includes a lookup table including a first gamma set and a second gamma set different from the first gamma set, and outputs a data signal based on either the first gamma set or the second gamma set, and
wherein the data driver outputs the data signal by reading out the first gamma set from the lookup table when the second period has the first horizontal length.

15. The display device of claim 14, wherein the data driver outputs the data signal by reading out the second gamma set from the lookup table when the second period has the second horizontal length.

16. The display device of claim 12, wherein the driver integrated circuit reduces a slew rate of the first gate signal when the second period has the second horizontal length to be less than the slew rate thereof when the second period has the first horizontal length.

17. The display device of claim 12, wherein the pixel of the pixels further includes:
an initialization transistor including a first electrode connected to the first node, a second electrode connected to a first initialization line which supplies a first initialization voltage, and a gate electrode connected to a second gate line which is a corresponding one of the gate lines, and
wherein the driver integrated circuit reduces the first initialization voltage when the second period has the second horizontal length to be lower than the first initialization voltage when the second period has the first horizontal length.

18. The display device of claim 9, wherein the first capacitor and the second capacitor are connected to each other in series.

19. The display device of claim 9, wherein the switch transistor is a P-type transistor.

20. An electronic device comprising:
a processor which provides input image data; and
a display device which displays an image based on the input image data,
wherein the display device includes:
pixels connected to gate lines, emission control lines, and data lines;
a gate driver which drives the gate lines; and
a driver integrated circuit which supplies a control signal to the gate driver, and
wherein a pixel of the pixels includes:
a light emitting element connected between a first power node and a second power node;
a first transistor that controls an amount of light emitting current flowing from the first power node to the second power node via the light emitting element based on a voltage of the first node;
a first capacitor connected between the first node and a fourth node;
a second capacitor connected between the fourth node and the first power node; and
a switch transistor connected between the first power node and the fourth node and including a gate electrode connected to a select power line supplied with a select voltage.
